(19) United States
(12) Patent Application Publication
(10) Pub. No.: US 2003/0197969 A1
(43) Pub. Date: Oct. 23, 2003

(54) Controlling low frequency track shape errors in hard disc drives employing self-propagated servo track writing

(76) Inventors: Gabor Szita, Newark, CA (US); Steven A. Koldewyn, Berthoud, CO (US)

Correspondence Address: David K. Lucente, Seagate Technology LLC, Intellectual Property - COL2LGL, 389 Disc Drive, Longmont, CO, 80503, US

(21) Appl. No.: 10/184,253

(22) Filed: Jun. 26, 2002

Related U.S. Application Data
(60) Provisional application No. 60/374,080, filed on Apr. 18, 2002.

(51) Int. Cl. G11B 5/596; G11B 21/02

(52) U.S. Cl. 360/77.08; 360/75

(57) ABSTRACT

The present invention maintains the low frequency run-out at a desired level during self-servo track writing. Included in the present invention is a method that keeps the low frequency track shape errors (the first few harmonics of the spindle rotational frequency) at a desired level during self-servo track writing. To that end, the present invention generates a correction signal. The correction signal is injected into the servo loop and modifies the path of the actuator while writing the next servo track, and thus modifies the shape of the next servo track. One embodiment injects the correction signal in the servo loop prior to the servo controller and combines it with the position error signal. Another embodiment injects the correction signal after the controller, and directly modifies the actuator input signal. The method does not require any extra disc revolutions, and therefore, it does not increase the time required for the self-servo writing process.

### CROSS-REFERENCE TO RELATED APPLICATIONS

This application claims priority from U.S. Provisional Application No. 60/374,080 filed on Apr. 18, 2002, entitled CONTROLLING LOW FREQUENCY TRACK SHAPE ERRORS IN HARD DISC DRIVES EMPLOYING SELF PROPAGATED SERVO TRACK WRITING.

### FIELD OF THE INVENTION

The present invention relates generally to servo systems in disc drives. In particular, the present invention relates to servo track writing.

### BACKGROUND OF THE INVENTION

In hard disc drives the head positioning servo system requires accurate

measurement of the location of the recording head relative to the disc surface. This is usually accomplished by writing special servo marks on the surface of the discs during production. Typically, these servo marks are written on a high accuracy servo track writing machine. However, the conventional servo track writing technique has serious limitations. As track density of hard disc drives increases, the servo track writing machine is not able to write the servo marks on the disc surface with the desired accuracy. Therefore, new techniques are being sought to overcome this problem.

One of the proposed approaches is self-servo track writing. The most well known approach to self-servo track writing was described in U.S. Pat. No. 4,414,589 by Oliver et al. The key idea of this approach is “self propagation.” Self propagation means that new tracks are written such that the position information to the servo system is derived by measuring the signal generated in the read head by the previously written track or tracks.

One issue in the self-propagated servo track writing process is to avoid the growth of track shape errors during radial propagation. Various methods have been proposed to overcome this issue. In many cases, however, these methods do not provide sufficient accuracy at low frequencies due to the high gain of the disc drive positioning servo loop at those frequencies. Furthermore, in certain servo writing schemes some seed tracks are pre-written on the media to aid the start of self-servo writing. These seed tracks may have significant run-out. It is desirable to keep the run-out equal on all tracks because the learning rate of typical run-out compensating schemes is slow, so variation in low-frequency run-out may result in poor seek performance.

### SUMMARY OF THE INVENTION

The present invention maintains the low frequency run-out at a desired level during self-servo track writing. Included in the present invention is a method that keeps the low frequency track shape errors (the first few harmonics of the spindle rotational frequency) at a desired level during self-servo track writing. To that end, the present invention modifies a track-following path of the actuator by injecting a correction signal into the servo loop. One embodiment injects the correction signal in the servo loop prior to the servo controller. The correction signal is combined with the position error signal. In another embodiment the correction signal is injected after the controller output and it is combined with the actuator input signal. The method does not require any extra disc revolutions, and therefore, it does not increase the time required for the self-servo writing process.

These and various other features as well as advantages which characterize the present invention will be apparent upon reading of the following detailed description and review of the associated drawings.

### BRIEF DESCRIPTION OF THE DRAWINGS

FIG. 1 illustrates a disc and actuator portion of a disc drive.

FIGS. 2A-2B illustrate servo wedges on a disc and certain information contained therein.

FIG. 3 illustrates track shape errors that are propagated during self-servo writing.

FIG. 4 is a block diagram of a servo loop that includes a track-following signal configuration.

FIG. 5 is a block diagram of a servo loop of one embodiment of the present invention.

FIG. 6 is a flow chart of one embodiment of a method of the present invention.

### DETAILED DESCRIPTION OF ILLUSTRATIVE EMBODIMENTS

While this invention is susceptible of embodiment in many different forms, there is shown in the drawings and will be described herein in detail specific embodiments thereof with the understanding that the present disclosure is to be considered as an exemplification of the principles of the invention and is not to be limited to the specific embodiments described.

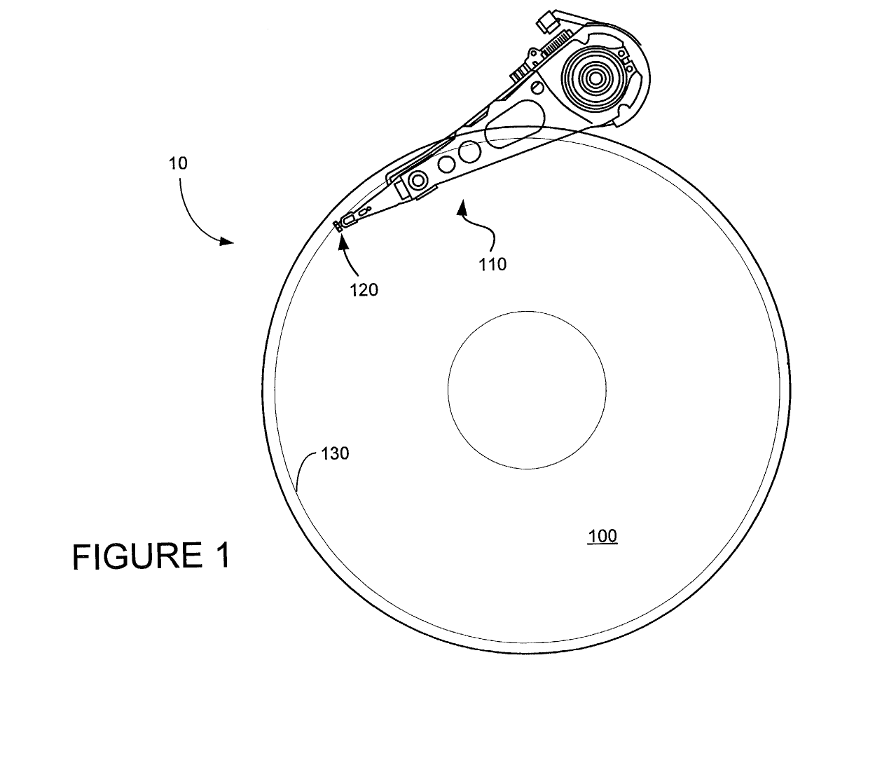

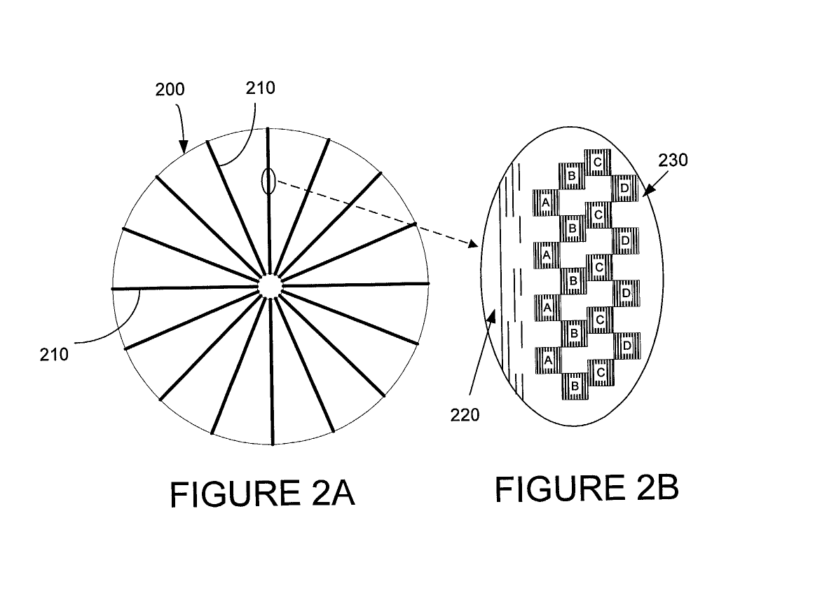

FIG. 1 shows certain portions of a hard disc drive 10. Included in hard disc drive 10 are a disc 100 and actuator 110. At the distal end of actuator 110 is a read/write head 120. Read/write head 120 is used to read and write data to disc 100 in a track format, such as a track 130. In a typical hard disc drive, servo sectors are used to determine the position of the head relative to the track center. The servo sectors are interspersed with data sectors along each track. FIG. 2A shows a disc 200 that is configured with servo track sectors 210.

Referring to FIG. 2B, servo sectors typically consist of a Grey code field 220 to provide coarse position information (track number), and a servo burst field 230 to provide fine position information. Servo bursts consist of one or more transitions that generate signals in the read transducer (head). This burst pattern is usually referred to as quadrature (or ABCD) burst pattern. The position of the head can be determined accurately by measuring the magnitude of the signal generated by the bursts as the head travels through the pattern.

One method of writing servo track is known as self-servo track writing. Self-servo track writing was first described in U.S. Pat. No. 4,414,589 by Oliver et al. The servo writing process according to that disclosure is summarized as follows. First, the actuator is moved to a limit stop and a reference track is written. Then a head is displaced an amount sufficient to reduce the amplitude of the reference track by a predetermined percentage—this is known as the “reduction rate”—that is related to the ultimate average track density. Thereafter, another reference track is written and the head is again stepped away from the second reference track an amount sufficient to again reduce the amplitude of the reference track by the predetermined percentage. This is continued until the disc is filled with reference tracks. If the average track density thus achieved is unsatisfactory, the reduction number is adjusted and the process is repeated. Once the correct reduction number is determined for a predetermined average track density, the servo tracks are written by alternatively writing servo and reference in alternating servo and informational sectors. The reduction number is used to determine the pitch of all tracks.

When a new track is being written during self-servo writing, the position

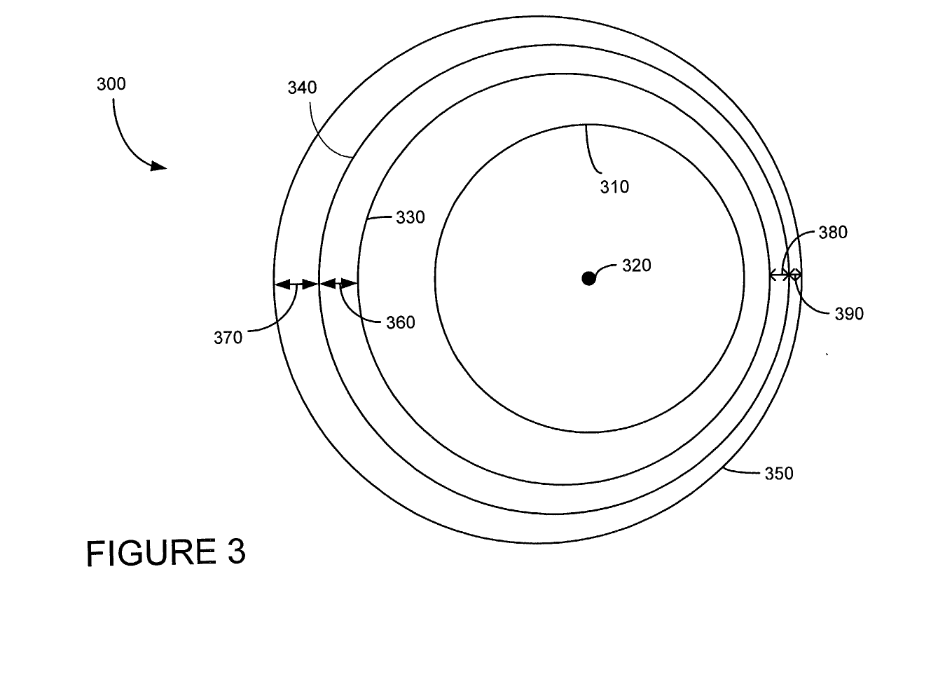

information to the servo system is provided by monitoring the signal generated in the read head by the magnetic marks written in the previous track. Therefore, the shape of the previous track will be inherited in the new track. In particular and with reference to FIG. 3, a portion of a disc 300 is shown that defines a center hole 310 that has an axial center 320. A first servo track 330 is written using a known self-servo writing technique. Due to some cause, servo track 330 is eccentric to axial center 320 as shown. The servo information in first servo track 330 is used to write a second servo track 340. The eccentricity of first servo track 330 is propagated to second servo track 340 as exemplified in FIG. 3. A third servo track 350 is written either from the servo information in the first or second servo track. The error propagation continues to third servo track 350.

Furthermore, if the servo system's closed loop gain is larger than unity at certain frequencies, then some irregularities in the shape of the previous track may even get amplified as the servo writing propagates. To illustrate this phenomenon, reference is made again to FIG. 3. Track separations 360, 370 are shown between respective track pairs 330, 340 and 340, 350. Track separation 370 is greater than track separation 360 due to the larger-than-unity closed-loop gain. Such differences will have an undesired effect on the track-following performance of the servo system. Likewise, track separations 380, 390 are shown between respective track pairs 330, 340 and 340, 350. Track separation 380 is greater than track separation 390 due to the larger-than-unity closed-loop gain. In this case, track squeeze may adversely effect data integrity.

The present invention at least minimizes the propagation of the track irregularities. To that end, the present invention provides signals that reduce such track irregularities. These signals are partly based on coefficients used in track following designs. Generally, one aspect of the present invention reduces the effect of track-following methods. A brief explanation of one such track following design follows.

In hard disc drives, the track shape error of servo tracks usually have relatively large frequency components at the first several harmonics of the spindle rotational frequency. Examples of a causes of a first (or fundamental) harmonic track shape error is eccentricity of the disc in response to shock and/or temperature. An example of a cause for a second harmonic track shape error is a “crease” caused in the disc by clamping forces. In particular, manufacturing irregularities of a spacer or debris that is located on a spacer between discs in a disc stack will cause the adjacent disc to warp when a clamping pressure is applied. Either case will cause servo track shape errors that contribute to disc runout.

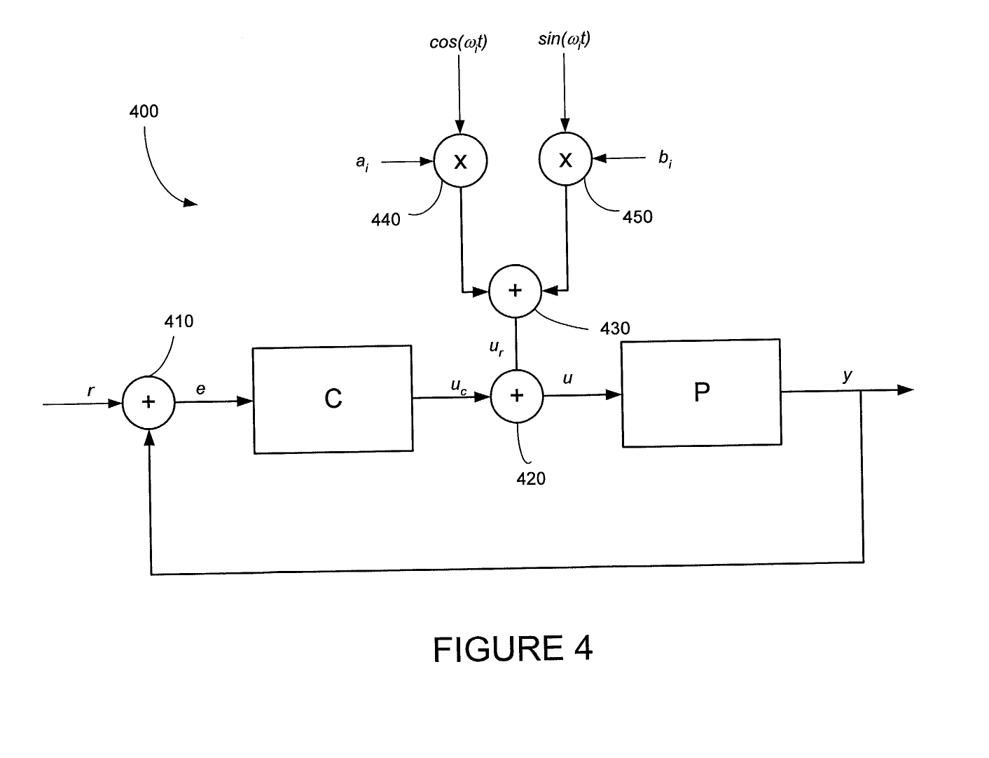

In many cases the basic servo system does not have sufficient gain to accurately follow those track shape errors. Therefore, known repetitive control is used in many disc drives to overcome this track-following problem. One known run-out compensation method was proposed by Alexei et al., “Advanced Methods for Repeatable Runout Compensation,” IEEE Transactions on Magnetics, vol. 31, no. 2 (March 1995) and generally shown in FIG. 4. A servo system 400 that includes a controller block C, an actuator block P and combiners 410-430 and multipliers 440, 450. In this figure, a head position signal y is combined at combiner 410 with a set or reference point signal r. The difference is a position error signal e.

Position error signal e is used by controller block C to generate a controller output signal u_{c} that will be input to actuator block P to control the actuator. Prior to that, controller output signal u_{c} is combined with a repeatable run-out compensation signal uᵣ at combiner 420 that results in an actuator input signal u. Signal uᵣ is generated by first scaling cos(ωᵢt) and sin(ωᵢt) by coefficients aᵢ and bᵢ at respective multipliers 440, 450, then combining them at combiner 430. The read and/or write head(s) in block P are positioned responsive to actuator input signal u. This scheme is known as adaptive feedforward compensation. The frequency of the injected sine and cosine signals ωᵢ is equal to the desired run-out frequency component to be compensated. The coefficients aᵢ and bᵢ are determined such that the actuator in the plant block P exactly follows the repeatable frequency component ωᵢ, i.e. the magnitude of the repeatable frequency component ωᵢ in position error signal e is equal to 0.

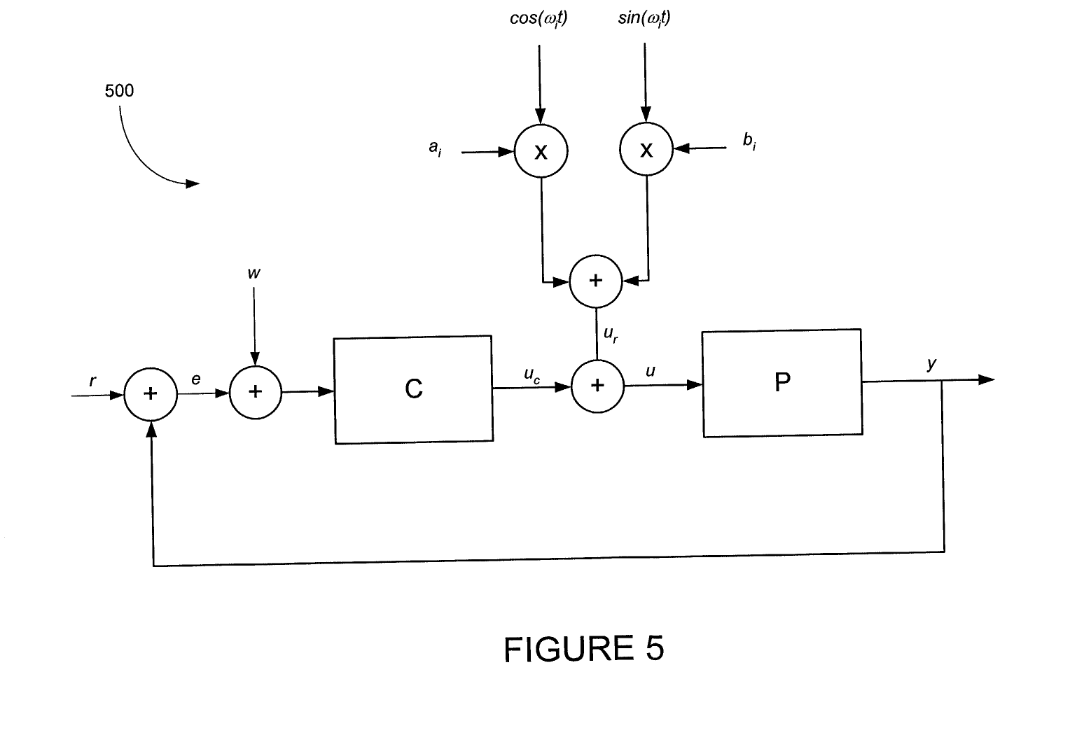

FIG. 5 shows the block diagram of the hard disc drive servo control system according to present invention. Similar to the description above for FIG. 4, the position error signal e is derived by subtracting the measured head position signal y from the set point input r. The set point input r is used to adjust the desired position of the actuator contained in block P. The sum of the position error signal e and the track shape correction signal w is the input of the controller C. The output of the controller u_{c} is summed with the repeatable run-out compensation signal uᵣ to produce signal u, which is fed into the input of the actuator P. The read and write transducers (heads) are positioned by the actuator. The output of the actuator block P is the head position y.

Note that magneto-resistive read heads are employed in many hard disc drives. In these drives the read and write heads may have significant offset, i.e. the position of the read and write heads may be different. For simplicity, it will be assumed that the offset of the read and write heads are zero, i.e. signal y represents the position of both heads. However, methods of the present invention can also be applied to situations where the reader-writer offset is not zero without modification.

As it was described above, irregularities in the shape of the previous track may get amplified as the self-servo writing propagates. This, in turn, may result in an unacceptably large deviation from the ideal perfectly circular track shape within a few hundred propagation steps. The purpose of the track shape correction signal w is to correct the imperfections of the track shape and to prevent unacceptable growth of errors. Preferably, the present invention at least minimizes growth of those frequency components that are compensated by the repeatable run-out method described with reference to FIG. 4.

To determine the track shape correction signal w, assume that the run-out frequency component to be corrected is ωᵢ. The method of the present invention is not limited to a single frequency component. If repeatable run-out compensation is applied at multiple frequencies ωᵢ, then the computations presented in the present invention can be repeated for all the desired frequency components. In other words, a track shape correction signal wᵢ is computed for each frequency component ωᵢ (i=1 . . . n), where n is the total number of frequency components compensated by the repeatable run-out compensator. Then these correction signals wᵢ are added to produce the final correction signal:

$$w = {\sum }_{i = 1}^{n} {w}_{i} \qquad Eq . 1$$

Also assume that the run-out compensator is fully settled when the computation presented in this section is performed, i.e. the multiplier factors aᵢ and bᵢ are determined such that the run-out compensation signal uᵣ perfectly compensates the repeatable run-out components at frequency ωᵢ. Then signal wᵢ is computed as follows:

wᵢ=Kᵢ[(aᵢ−aᵢ₀) cos (ωᵢt+φᵢ)+(bᵢ−bᵢ₀) sin (ωᵢt+φᵢ)] Eq. 2

where Kᵢ is the track shape correction gain and φ_{I} is the track shape correction phase. The typical values of Kᵢ and φ_{I} are:

$${K}_{i} = 0.1 \frac{1}{\vert C ( j {ω}_{i} ) \vert} \qquad Eq . 3$$

φᵢ=−phase(C(jωᵢ)) Eq. 4

where C is a multiplier due to the controller and 0.1 (10%) is the compensation scale factor. 10% was determined empirically. This factor can be increased or decreased as desired, but track squeeze is preferably considered when making that determination. For example, a factor of one (100%) may remove all error in one propagation step, but it may cause large track squeeze between the first and second track, i.e. the distance between the first and second track may be unacceptably small at certain circumferential locations, or the second track may even overwrite the previous track.

The scalars aᵢ₀ and bᵢ₀ can be used to keep the run-out at a predetermined level instead of zero during the self-servo write propagation process. Typically, in systems where seed tracks are used to start the propagation process, it may be desirable that propagated tracks inherit the initial run-out of the seed tracks. In this case the factors aᵢ₀ and bᵢ₀ are calibrated by recording the values of a and b, after the run-out compensator is fully settled following the seed tracks, and setting aᵢ₀ and bᵢ₀ equal to these recorded values. In self-servo writing systems without seed tracks, the desired run-out is typically zero at all frequencies, so aᵢ₀ and bᵢ₀ are typically set to 0.

It can be shown that when signal wᵢ is applied during the self-servo write propagation process, the frequency component ω_{I} of track shape errors is maintained at:

Eᵢ=Gᵢ[aᵢ₀ cos (ωᵢt+αᵢ)+(bᵢ₀ sin(ωᵢt+αᵢ)] Eq. 5

where Gᵢ and αᵢ are the gain and phase shift of the actuator transfer function P at frequency ωᵢ, respectively:

Gᵢ=|P(jωᵢ)| Eq. 6

αᵢ=phase(P(jωᵢ)) Eq. 7

In FIGS. 4 and 5, block C can be implemented as hardware, software-controlled hardware or a combination of both. Likewise, the correction signal can be generated in hardware, software-controlled hardware or a combination of both.

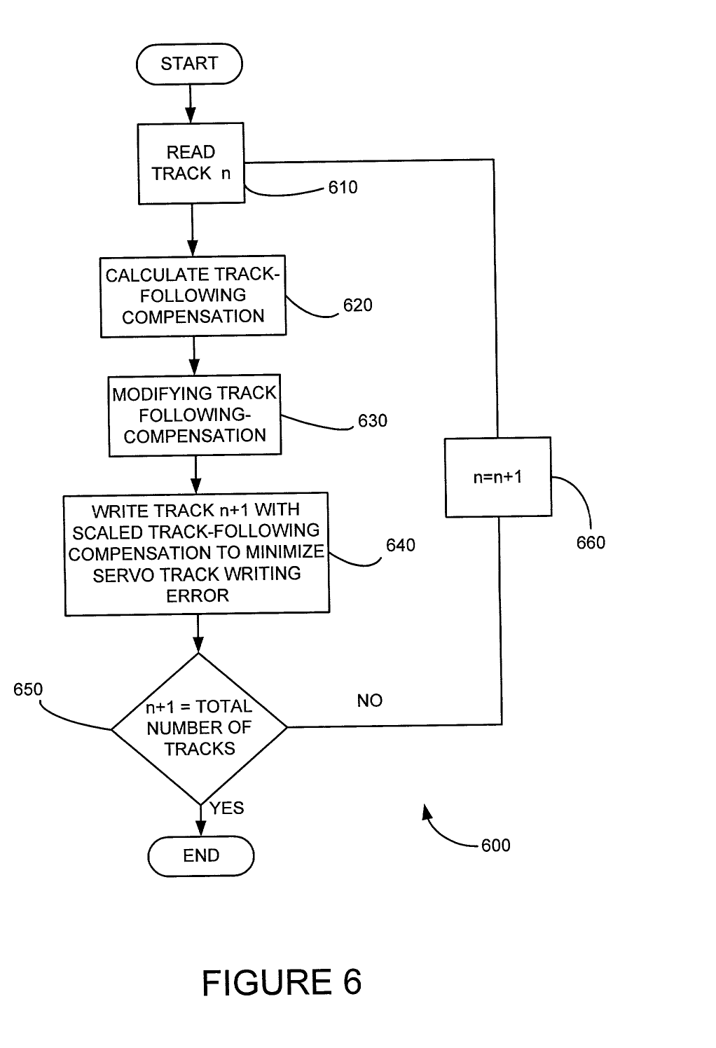

FIG. 6 illustrates general method steps 600 of the present invention. Prior to step 610, a first servo track n is written on the disc. These tracks can be generated by the self servo writing process, or may be written on a conventional servo writing machine. If the servo writing machine is not able to provide satisfactory accuracy, an alternate approach is to form an accurate guide pattern on the discs before they are assembled into the drive by optical, mechanical, chemical, electrostatic, or magnetic means. At step 610, that first track n is followed. Then at step 620 the track-following coefficients (or multiplier factors) aᵢ and bᵢ are calculated from following track n. This may require one or more revolutions to read and adjust aᵢ and bᵢ until the position error signal e is reduced to zero or below a certain acceptable threshold. If aᵢ and bᵢ are already settled, then the present invention requires no additional time for self-servo writing. At step 630, the present invention modifies the track-following compensation by scaling and/or phase shifting. This modified track-following compensation is then applied to the servo loop at step 640 to minimize the track shape error when writing track n+1. Step 650 determines if all the servo tracks have been written to the disc. If yes, the method ends. If no, then at step 660 n is incremented. Step 610 is repeated along with other steps as described.

In a further embodiment, the method of the present invention will scale the coefficients aᵢ and bᵢ, and combine the modified coefficients directly with the actuator input signal. In this example, the circuit of FIG. 4 would be used. Coefficients aᵢ and bᵢ would be scaled by, for example, 10% to modify the path of the actuator while writing the next track, and thus reducing the track shape error of the next track. In addition, phase adjustments can be made to signals cos(ωᵢt) and sin(ωᵢt).

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts and values for the described variables, within the principles of the present invention to the full extent indicated by the broad general meaning of the terms in which the appended claims are expressed. For example, the particular elements may vary depending on the particular application for the servo system while maintaining substantially the same functionality without departing from the scope and spirit of the present invention. In addition, although the preferred embodiment described herein is directed to a servo loop for a disc drive system, it will be appreciated by those skilled in the art that the teachings of the present invention can be applied to other systems, without departing from the scope of the present invention. Further, the written-in repeatable run-out compensation scheme may be implemented in hardware or software. The disc drive can be based upon magnetic, optical, or other storage technologies and may or may not employ a flying slider.

What is claimed is:

1. A method comprising the step of applying a modified track-following compensation signal to at least minimize track shape error for self-servo track writing.

2. The method of claim 1 wherein the modified track compensation signal is provided prior to a servo controller.

3. The method of claim 1 wherein the modified track compensation signal is provided after a servo controller.

4. The method of claim 1 wherein the modified track signal is an amplitude-adjusted track-following signal.

5. The method of claim 1 wherein the modified track signal is a phase-adjusted track-following signal.

6. The method of claim 1 wherein the modified track signal is an amplitude-adjusted and phase-adjusted track-following signal.

7. The method of claim 1 wherein the modified track-following compensation signal is used to at least minimize track shape error for at least one frequency.

8. The method of claim 1 wherein the modified track-following compensation signal includes scalers to maintain a track shape error at a predetermined level.

9. The method of claim 1 wherein a servo track is written using a previously written servo track.

10. The method of claim 1 wherein one servo track is used to write at least another servo track.

11. A method of a servo system comprising the steps of:
determining track-following signals;
generating a compensation signal at least partly from the track-following signals; and
applying the compensation signal to at least minimize propagated servo writing errors.

12. The method of claim 11 wherein the servo writing errors are caused by self-servo writing.

13. The method of claim 11 wherein the compensation signal is provided to a servo controller.

14. A servo controller loop comprising:
a controller block; and
an actuator block coupled to the controller block, wherein a modified track-following signal is injected into the loop to at least minimize self-servo track writing errors.

15. The loop of claim 14 wherein the modified track-following signal is injected before the controller block.

16. The loop of claim 14 wherein a track-following signal is injected between the controller block and the actuator block.

17. The loop of claim 14 wherein the modified track-following signal is injected between the controller block and the actuator block.
